(19) United States
(12) Patent Application Publication
(10) Pub. No.: US 2005/0110763 A1
(43) Pub. Date: May 26, 2005

(54) Personal calculator

(76) Inventor: Alain Henri Bernard Chemla, Paris (FR)

Correspondence Address: BARNES & THORNBURG, P.O. BOX 2786, CHICAGO, IL, 60690-2786, US

(21) Appl. No.: 10/961,103

(22) Filed: Oct. 8, 2004

(30) Foreign Application Priority Data
Oct. 10, 2003 (FR) 0311914

(51) Int. Cl. G09G 5/00

(52) U.S. Cl. 345/170

(57) ABSTRACT

The personal calculator (10) comprises a keypad (14), which comprises a plurality of keys (20, 22, 24, 26), for inputting calculation operations to be carried out, a display screen (16) and a central information processing unit (18) which is connected to the keypad (14) and to the display screen (16). The information processing unit (18) is suitable for controlling the display on the screen (16) of the results of operations input via the keypad (14). It comprises means for illuminating the calculator and a control unit which is suitable for controlling the illumination means according to at least two states which are differentiated in accordance with the calculation operations input by the operator.

The present invention relates to a personal calculator of the type comprising a keypad, which comprises a plurality of keys, for inputting calculation operations to be carried out, a display screen and a central information processing unit, which is connected to the keypad and to the display screen and which is suitable for controlling the display on the screen of the results of operations input via the keypad.

Personal calculators such as portable pocket calculators or pocket calculators for the office which are used by accountants comprise a keypad formed by an assembly of numerical keys, mathematical operator keys and function keys, such as a clear key or a memory key. These keys are each marked with an inscription in order to distinguish them and identify their function. The calculator further comprises a display screen on which the numbers input via the keypad appear in monochrome characters, as well as the result of the calculation operation carried out by the calculator.

A calculator of this type functions in a completely satisfactory manner but the operator using the calculator must be vigilant with regard to the keys which he activates and the interpretation of the result displayed by the screen. No help is given to the operator by the calculator.

The object of the invention is to provide a personal calculator which is easier to use.

To this end, the subject-matter of the invention is a personal calculator of the aforementioned type, characterised in that it comprises means for illuminating the calculator and a control unit which is suitable for controlling the illumination means according to at least two states which are differentiated in accordance with the calculation operations input by the operator.

According to specific embodiments, the calculator comprises one or more of the following features:
the illumination means comprise luminous sources which are associated with each key of the keypad and the control unit is suitable for ensuring selective control of the luminous sources in accordance with the calculation operations input by the operator;
the keypad comprises numerical keys and mathematical operator keys, and the luminous sources which are associated with the numerical keys and the mathematical operator keys, respectively, are of different colours;
the control unit is adapted to ensure, when a key is depressed, that the luminous source associated with the depressed key is illuminated according to a specific illumination mode for a predetermined length of time;
the central information processing unit comprises means for detecting a definition error for a calculation to be carried out, and the control means are adapted to ensure that at least one luminous source, which is associated with at least one key of the keypad, flashes when such an error is detected;
the illumination means comprise two luminous sources which are associated with the screen in order to illuminate the screen according to two differentiated states, and the control unit is suitable for ensuring that the screen is illuminated according to one of these two differentiated states in accordance with a feature of the information displayed on the screen;
the control unit is adapted to ensure, when a number is displayed on the screen, that the screen is illuminated according to one of these two differentiated states in accordance with the sign of the number displayed on the screen; and
the two luminous sources are of different colours, the screen being adapted to display numbers and symbols of the same colour, and the luminous sources are adapted to allow the background of the screen to be illuminated in the colour of one or other of the luminous sources.

The invention will be better understood from a reading of the following description, given purely by way of example and with reference to the drawings, in which:

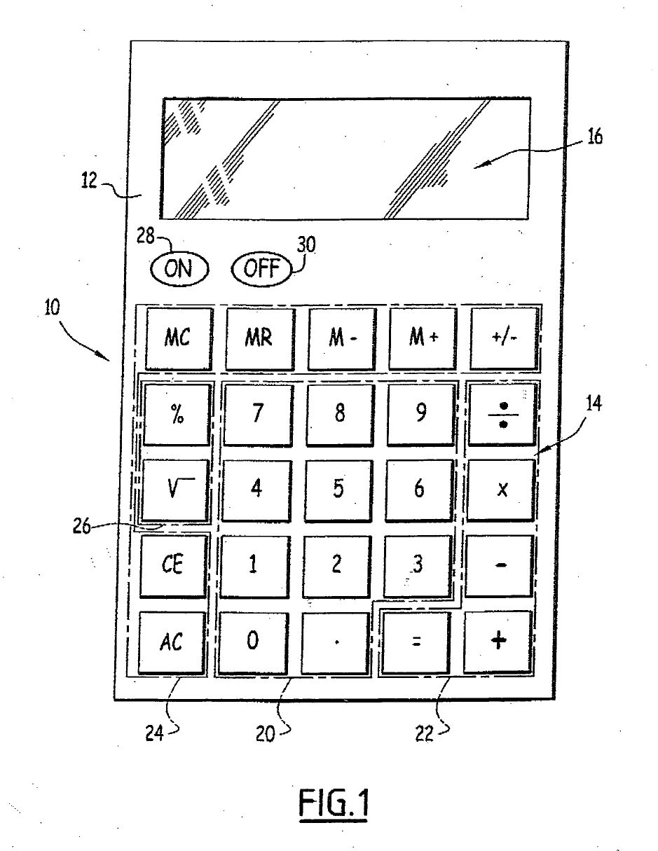

FIG. 1 is a front view of a personal calculator according to the invention; and

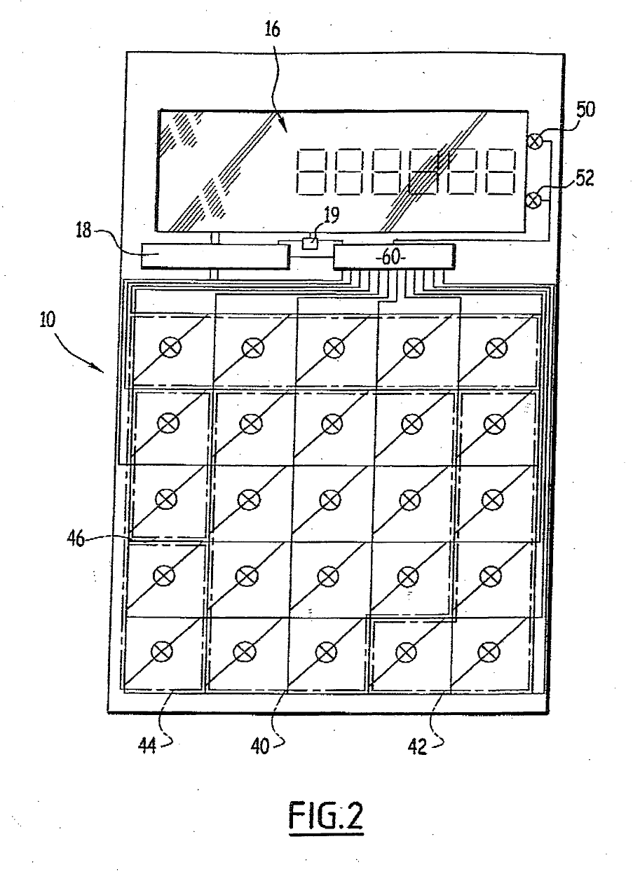

FIG. 2 is a front view of the calculator of FIG. 1, the front face having been removed.

The calculator 10 according to the invention substantially comprises a casing 12 which carries, at the front face thereof, a keypad 14 and a screen 16. The screen 16 is, for example, a liquid crystal screen. The keypad and the screen are connected to a central information processing unit 18 which can be seen in FIG. 2. The screen 16 and the central unit 18 are supplied with power from a battery 19.

As known per se, the central information processing unit comprises means for receiving information from the keypad and is adapted to carry out the calculations corresponding to the calculation operations input via the keypad. The central information processing unit 18 further comprises means for controlling the screen 16 in order to allow the numbers entered via the keypad, as well as the results of the calculations carried out, to be displayed.

The keypad 14 comprises eleven numerical keys 20 corresponding to the ten figures from 0 to 9 and the decimal point. It further comprises five keys 22 corresponding to the four mathematical operators +, −, × and ÷ as well as the key =. Furthermore, it comprises an assembly of function keys 24, such as a clear key and memory keys. Finally, it comprises keys 26 for complex functions, such as a percentage key and a function key which allows the square root of a number to be calculated.

Finally, the keypad has a key 28 marked “on” which allows the calculator to be switched on and a key 30 marked “off” which allows the calculator to be switched off.

According to the invention, the calculator comprises means for illuminating the calculator according to at least two illumination states which are differentiated in accordance with the calculation operations input by the operator.

These illumination means comprise in particular an electro-luminescent diode associated with each key of the keypad.

More precisely, and as illustrated in FIG. 2, a matrix of electro-luminescent diodes is arranged below the keypad 16, one diode being associated with each key and being arranged immediately behind this key.

In order to allow the light produced by the diode to be visible, each key is, for example, transparent, which allows it to be illuminated from behind by the associated diode in this manner.

By way of a variant, each key is opaque and has only a frosted pattern which allows light to pass through. According to another variant, each key is bordered by a transparent-frame which is arranged in the casing 12 and which allows the periphery of the corresponding key to be illuminated from the subjacent associated diode.

The diodes associated with each type of key are preferably of different colours. For example, a first assembly of red electro-luminescent diodes 40 is arranged below the numerical keys 20. Blue electro-luminescent diodes 42 are arranged below the mathematical operator keys 48, yellow electro-luminescent diodes 44 being arranged below the function keys 24 and orange electro-luminescent diodes 46 being positioned below the complex function keys 26. The keys 28 and 30 are also illuminated by electro-luminescent diodes which are not shown.

Furthermore, two differently coloured diodes 50, 52 for illuminating the background of the screen 16 are arranged in the immediate vicinity of the screen. For example, the diode 50 is green whilst the diode 52 is red.

These diodes are arranged in such a manner that they are capable of ensuring that the screen 16 is illuminated from behind.

The calculator further comprises a diode control unit 60. The unit 60 is connected to the central information processing unit 18 and to the calculator supply battery 19. This unit 60 allows each diode to be individually supplied or not in accordance with information received from the central information processing unit 18.

To this end, the central information processing unit 18 is connected to the control unit 60 via an information transmission link which allows the keypad key which has just been depressed, the result of an operation carried out by the calculator or an error state to be communicated to the control unit.

The control unit 60 is programmed to ensure that each of the diodes is selectively supplied in accordance with a predetermined algorithm and in accordance with information from the central information processing unit.

In particular, the unit 60 is adapted to bring about the temporary illumination of the electro-luminescent diode associated with each key depressed by the operator. This illumination occurs, for example, for a period of half a second.

In this manner, a key is illuminated for half a second in the colour of the associated diode when the key is depressed.

Furthermore, the control unit 60 ensures that the green diode 50 or the red diode 52 is illuminated in accordance with the sign of the number displayed on the screen 16. In this manner, if the number is positive, that is to say, greater than 0, the green diode is illuminated so that the number appears on a green background. Conversely, if the number is negative, that is to say, less than 0, the red diode is illuminated so that the number appears on a red background on the screen 16.

Furthermore, the control unit 60 ensures, when a calculation error is detected by the information processing unit 18, that all of the keys of the keypad flash simultaneously for a predetermined length of time of, for example, 2 seconds. To this end, all of the diodes 42 to 46 are illuminated and extinguished successively and rapidly.

For example, this is the case when the square root calculation key is depressed when the figure appearing on the screen is negative.

It will be appreciated that the use of illumination means which allow the calculator to be brought into a plurality of differentiated states of illumination allows the operator to determine the type of operation he is carrying out. Each time the operator presses a numerical key or a mathematical operator key, a light illuminates the key which has just been depressed in a colour which represents the nature of the key. In this manner, even without the operator having to identify precisely the key which has just been depressed, he is able to determine the type of key which has just been depressed which is generally sufficient to detect a potential error.

In the same manner, the illumination of the screen in a colour depending on the sign of the result of the operation allows the operator to quickly form an idea of this result, without thereby being aware of the precise result displayed on the screen.

In this manner, the different illumination states of the calculator allow the use thereof to be facilitated.

By way of a variant, the keys of the calculator are all permanently illuminated and the key which has just been depressed is temporarily illuminated with greater intensity. To this end, the control unit 60 ensures a greater difference in potential at the terminals of the electro-luminescent diode associated with the key which has just been depressed.

The invention relates to all types of calculator, whether or not they be provided with an integral printer. These calculators can be small devices which fit into a pocket or larger devices which are intended to be placed on a desk.

1. Personal calculator (10) comprising a keypad (14), which comprises a plurality of keys (20, 22, 24, 26), for inputting calculation operations to be carried out, a display screen (16) and a central information processing unit (18), which is connected to the keypad (14) and to the display screen (16) and which is suitable for controlling the display on the screen (16) of the results of operations input via the keypad (14), characterised in that it comprises means (40, 42, 44, 46, 50, 52) for illuminating the calculator and a control unit (60) which is suitable for controlling the illumination means according to at least two states which are differentiated in accordance with the calculation operations input by the operator.

2. Calculator according to claim 1, characterised in that the illumination means comprise luminous sources (40, 42, 44, 46) which are associated with each key (20, 22, 24, 26) of the keypad and the control unit (60) is suitable for ensuring selective control of the luminous sources in accordance with the calculation operations input by the operator.

3. Calculator according to claim 2, characterised in that the keypad (14) comprises numerical keys (20) and mathematical operator keys (22), and in that the luminous sources (40, 42) which are associated with the numerical keys (20) and the mathematical operator keys (22), respectively, are of different colours.

4. Calculator according to claim 2 or 3, characterised in that the control unit (60) is adapted to ensure, when a key is depressed, that the luminous source associated with the depressed key is illuminated according to a specific illumination mode for a predetermined length of time.

5. Personal calculator according to any one of claims 2 to 4, characterised in that the central information processing unit (18) comprises means for detecting a definition error for a calculation to be carried out, and in that the control means (60) are adapted to ensure that at least one luminous source (40, 42, 44, 46), which is associated with at least one key (20, 22, 24, 26) of the keypad, flashes when such an error is detected.

6. Calculator according to any one of the preceding claims, characterised in that the illumination means comprise two luminous sources (50, 52) which are associated with the screen (16) in order to illuminate the screen according to two differentiated states, and in that the control unit (60) is suitable for ensuring that the screen (16) is illuminated according to one of these two differentiated states in accordance with a feature of the information displayed on the screen.

7. Personal calculator according to claim 6, characterised in that the control unit (60) is adapted to ensure, when a number is displayed on the screen (16), that the screen is illuminated according to one of these two differentiated states in accordance with the sign of the number displayed on the screen.

8. Personal calculator according to claim 6 or 7, characterised in that the two luminous sources (50, 52) are of different colours, the screen being adapted to display numbers and symbols of the same colour, and in that the luminous sources are adapted to allow the background of the screen to be illuminated in the colour of one or other of the luminous sources.
